(19) United States
(12) Patent Application Publication
(10) Pub. No.: US 2020/0297163 A1
(43) Pub. Date: Sep. 24, 2020

(54) GRILL HANDLE

(71) Applicant: Robert DeAngelis, Yorktown Heights, NY (US)

(72) Inventor: Robert DeAngelis, Yorktown Heights, NY (US)

(21) Appl. No.: 16/358,954

(22) Filed: Mar. 20, 2019

(51) Int. Cl. A47J 37/07

(52) U.S. Cl. CPC A47J 37/0786

(57) ABSTRACT

Embodiments of a handle for a barbeque grill cover are disclosed. The handle may have a central portion adapted to be mounted to a surface of the cover that has a width approximately equal to a width of the front surface of the cover. The handle has first and second end portions extending from respective first and second ends of the central portion beyond respective first and second side peripheries and below a bottom periphery of the front surface of the cover to provide first and second gripping surfaces that are beyond the respective side peripheries and below the bottom periphery of the front surface of the cover in order to protect a user from exposure to from heat. flame, or grease spatter from the cooking surface. The handle may be provided integral to the cover or may be provided as a retrofit handle for attachment to an existing handle.

### FIELD

This disclosure relates generally to a handle for a cover of a grilling or cooking apparatus, such as an outdoor barbecue grill.

### BACKGROUND

Outdoor and indoor barbecue grills have been in residential and commercial use for many years. Fuels such as propane, natural gas, charcoal, and others are typically used to provide heat for cooking. Conventional barbecue grill products include a cooking surface with a hinged cover portion that can be positioned in a closed position over the cooking surface and in an open position to provide access to the cooking surface. The cover typically has one or more handles for use in moving the cover between the open position and the closed position. However, the handles are typically positioned on the cover in a manner that exposes a user to the heat. flame, or grease spatter from the cooking surface when opening or closing the cover because the user is forced to reach over the cooking surface to grip the handles as the cover moves to or from a fully open position. This risk can be significantly increased when a user is not tall in stature or has shorter arms.

As shown in FIG. 1A, a conventional grill has a cover 10 that is positioned over a cooking surface (not shown) in base 20. A side-shelf 16 is provided adjacent to each side of the cooking surface. Control knobs 22 are provided in a control panel 21. Caster wheels 23 are provided to support base 20. Handle 14 is fastened to the grill cover 10 with brackets 12 that are positioned inset from the front edges of the front surface of grill cover 10. FIG. 1B shows a prior art grill having a handle 15 that spans the full width of the front surface of cover 10, with the brackets 12 positioned directly adjacent to the front edges of the front surface of grill cover 10. FIG. 1C shows a prior art grill having a curved handle 18 that is directly connected at each end thereof to the front surface of cover 10. The positions of handles 14, 15, and 18 each require a user to reach over the cooking surface when opening or closing grill cover 10. The need to reach over the cooking surface exposes the user to heat, flames, and/or grease spatter emitted from the cooking surface.

Accordingly, there is a need for an improved grill handle that overcomes the problems stated above.

### SUMMARY

In a first aspect, a handle for a barbeque grill cover includes a central portion adapted to be mounted to a front surface of the barbeque grill cover that has a width approximately equal to a width of the front surface of the barbeque grill cover. The handle also includes a first end portion extending from a first end of the central portion beyond a first side periphery of the front surface of the barbeque grill cover to provide a first gripping surface that is beyond the first side periphery of the front surface of the barbeque grill cover.

In one further embodiment, the handle has a second end portion extending from a second end of the central portion beyond a second side periphery of the front surface of the barbeque grill cover to provide a second gripping surface that is beyond the second side periphery of the front surface of the barbeque grill cover. In another further embodiment, the first end portion extends below a bottom periphery of the front surface of the barbeque grill cover to provide an extended first gripping surface that is beyond the first side periphery of the front surface of the barbeque grill cover and below the bottom periphery of the front surface of the barbeque grill cover. In a still further embodiment, the second end portion extends below a bottom periphery of the front surface of the barbeque grill cover to provide an extended second gripping surface that is beyond the second side periphery of the front surface of the barbeque grill cover and below the bottom periphery of the front surface of the barbeque grill cover. The first and second end portions may curved and form a u-shape. Alternatively, the first and second end portions may be curved and form a closed loop. Still further, the central portion may be straight. The central portion and the first and second end portions may be formed from one of a metal material, a durable plastic material, or a wood material. A thermally insulated material may cover the first gripping surface of the first end portion and the second gripping surface of the second end portion.

In a second aspect, a handle for a barbeque grill cover has a straight central portion adapted to be mounted to a rear surface of the barbeque grill cover that has a width greater than a width of the rear surface of the barbeque grill cover. The handle also has a first end portion extending forward from a first end of the central portion to a point beyond a plane formed by the front surface of the barbeque grill cover and then extending downward to form a u-shape to provide a first gripping surface at the base of the u-shape that is beyond a first side periphery of a front surface of the barbeque grill cover and below a bottom periphery of the front surface of the barbeque grill cover.

In a further embodiment, the handle has a second end portion extending forward from a second end of the central portion to a point beyond a plane formed by the front surface of the barbeque grill cover and then extending downward to form a u-shape to provide a second gripping surface at the base of the u-shape that is beyond a second side periphery of the front surface of the barbeque grill cover and below a bottom periphery of the front surface of the barbeque grill cover.

In a third aspect, a handle for a barbeque grill cover has a vertical member adapted to be attached at a proximal end thereof to a side surface of the barbeque grill cover. The vertical member extends below a bottom periphery of the side surface of the barbecue grill cover. The handle also has a horizontal handle portion secured to a distal end of the vertical member. The horizontal handle portion provides a gripping surface that is beyond a side periphery of a front surface of the barbeque grill cover and below a bottom periphery of the side surface of the barbecue grill cover.

In a fourth aspect, a retrofit handle for a barbeque grill cover having an integral handle has a vertical member extending below a bottom periphery of a front surface of the barbecue grill cover. The retrofit handle also has a horizontal handle portion secured to a distal end of the vertical member. The horizontal handle portion provides a gripping surface that is beyond a side periphery of the front surface of the barbeque grill cover and below the bottom periphery of the side surface of the barbecue grill cover. The retrofit handle also has a clamping mechanism for securely attaching the vertical member to the integral handle of the barbeque grill cover at a proximal end of the vertical member.

In one further embodiment, the clamping mechanism has a first horizontal plate securely attached to the vertical member at the proximal end thereof, a second horizontal plate adapted to be positioned between the integral handle and an exterior surface of a front surface of the barbeque grill cover, and hardware for securely fastening the first horizontal plate to the second horizontal plate. The hardware may be mating nuts and bolts. In addition, a spacer may be positioned between the first horizontal plate and the vertical member to ensure that the vertical member is positioned beyond the side periphery of the front surface of the barbeque grill cover.

In another further embodiment, the clamping mechanism has a first vertical plate securely attached to the vertical member at a proximal end thereof and adapted to be positioned above or below the integral handle, a second vertical plate adapted to be positioned below or above the integral handle, and hardware for securely fastening the first vertical plate to the second vertical plate. The hardware may be mating nuts and bolts.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, is given by way of example and not intended to limit the present disclosure solely thereto, will best be understood in conjunction with the accompanying drawings in which:

FIGS. 1A, 1B and 1C are each diagrams showing a perspective view of three different versions of conventional grills;

FIG. 2 is a diagram showing a perspective view of a first embodiment of a grill handle according to the present disclosure;

FIG. 3 is a diagram showing a perspective view of a second embodiment of a grill handle according to the present disclosure;

FIG. 4A is a diagram showing a perspective view of a third embodiment of a grill handle according to the present disclosure, and FIG. 4B is a diagram showing a rear view of the third embodiment;

FIG. 5 is a diagram showing a perspective view of a fourth embodiment of a grill handle according to the present disclosure;

FIG. 6A is a diagram showing a front view of a fifth embodiment of a grill handle according to the present disclosure, and FIG. 6B is a diagram showing a side view of the fifth embodiment;

FIG. 7A is a diagram showing a front view of a sixth embodiment of a grill handle according to the present disclosure, FIG. 7B is a side view of the sixth embodiment, FIG. 7C is a top view of the sixth embodiment, and FIG. 7D is a diagram showing an enlarged detail of top plate of the sixth embodiment.

### DETAILED DESCRIPTION

In the present disclosure, like reference numbers refer to like elements throughout the drawings, which illustrate various exemplary embodiments of the present disclosure. The embodiments illustrated below are not intended to be exhaustive or to limit the disclosure to the precise form disclosed. These embodiments are chosen and described to best explain the principle of the disclosure and its application and practical use and to enable others skilled in the art to best utilize the disclosure.

The embodiments of the grill handle of the present disclosure are intended to either be incorporated into a new grill product, or be retrofit onto existing products. All of the embodiments feature a grill handle which includes a handle portion which extends beyond the front outside edge (or edges) of the front surface of the cover and below the lower edge of the front surface of the cover in order to make the cover easier and safer to use. When the grill handle includes a handle portion in this manner, the user is able to open and close the cover without any exposure to the cooking surface. The handle and associated parts are preferably made from a metal (e.g., stainless steel), and may also include portions formed from a durable thermoplastic material or wood.

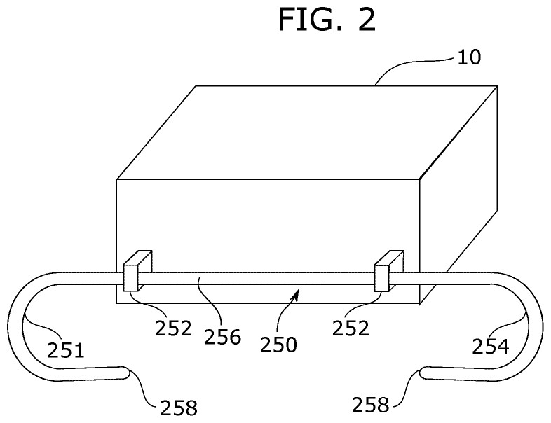

Referring now to FIG. 2, in a first embodiment of the present disclosure, a grill cover 10 includes a handle 250 coupled to grill cover 10 via brackets 252. Handle 250 preferably includes a central (preferably straight) portion 256 and two end portions 254 which are each curved into a sideways u-shape and extend beyond the respective front edge of the front surface of grill cover 10 (i.e., outside of the plane of the cooking surface) and preferably below the plane of the horizontal surface of the grill cooking surface when grill cover 10 is in a closed position over the cooking surface. The central portion 256 is approximately equal to a width of the front surface of grill cover 10 and each of the two end portions 254 extend beyond the respective side periphery of the front surface of grill cover 10 defined by the width and, preferably, also extend below the lower front edge (bottom periphery) of the front surface of grill cover 10. By relocating the gripping surface of handle 250 to a position outside (i.e., outside of the side periphery of the front surface of grill cover 10) and, preferably, below the plane of the cooking surface (i.e., below the bottom periphery of the front surface of grill cover 10) when the grill cover is in the closed position, a user is able to avoid reaching over the heated cooking surface then opening and closing the grill cover 10. The formation of end portions 254 into a u-shape avoids any sharp edges that could be a risk to the operator or others in the vicinity of the grill. The end tip portions 258 of the handle 250 are preferably angled slightly inwards towards the grill cover 10 to avoid catching clothing or other items during use. In a further embodiment, the gripping portions of the end portions 254 may be covered with (or formed from) a thermally insulated material in order to protect the user from excessive heat during use. Although two end portions 254 are shown in FIG. 2, in some cases only one end portion 254 may be required and the other end may simply be terminated close to but beyond the associated bracket 252. Furthermore, in some cases each end portion 254 of handle 250 may only need to extend beyond the outside edge of the front panel of cover 10 to provide acceptable usage.

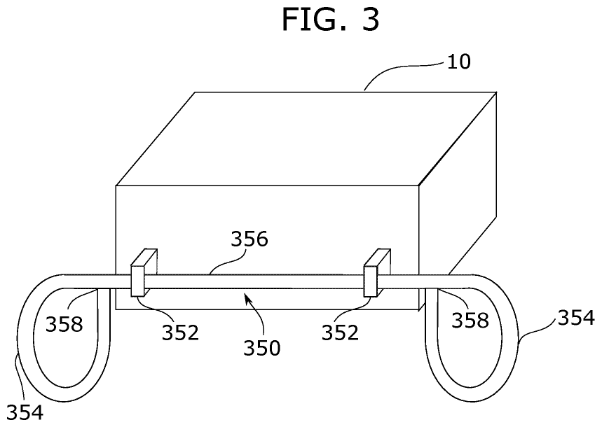

A second embodiment of the grill handle of the present disclosure is shown in FIG. 3. In particular, grill handle 350 is coupled to grill cover 10 via brackets 352 and preferably includes a central (preferably straight) portion 356 and two curved end portions 354. Here, however, the curved end portions 358 form a closed loop (or nearly closed loop) so that each end tip portion 358 is closely adjacent to a portion of a portion of respective end portion 354 beyond the respective side periphery of the front surface of grill cover 10. Since a bottom portion of each closed loop curved end portion 358 is beyond the respective side periphery of the front surface of grill cover 10 and below the bottom periphery of the front surface of grill cover 10, a gripping surface is provided that ensures that a user is able to avoid reaching over the heated cooking surface when opening and closing the grill cover 10. The closed loop nature of the curved end portions 358 of grill handle 350 ensures that there are no edges available to catch on clothing or other items. A further embodiment may be provided in which the gripping portions of the curved end portions 354 are covered with (or formed from) a thermally insulated material in order to protect the user from excessive heat during use.

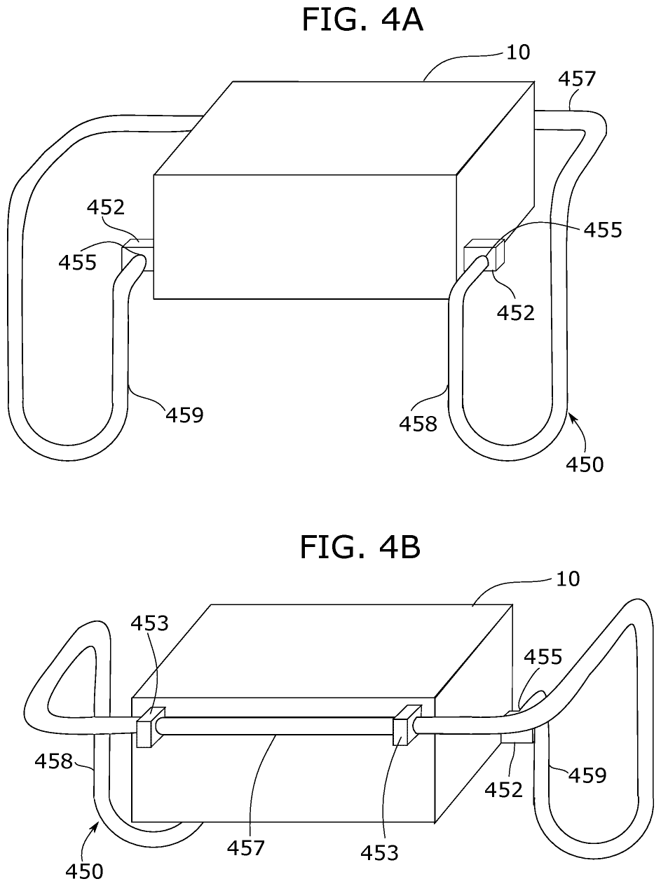

A third embodiment of a grill handle 450 is shown in FIGS. 4A and 4B. Grill handle 450 is coupled to the grill cover 10 via brackets 452 on side portions of the grill cover 10 and brackets 453 on a rear portion of cover 10 (via a straight central portion 457). Grill handle 450 also preferably has two curved members 458 and 459 each providing a gripping surface to the side of and lower than the plane of the grilling surface. In some cases, one of the two curved members 458 and 459 may be omitted. The straight central portion 457 is adapted to be mounted to a rear surface of the barbeque grill cover and has a width greater than a width of the rear surface of the barbeque grill cover. Each end portion 458, 459 extends forward from a first end of the central portion 457 to a point beyond a plane formed by the front surface of the barbeque grill cover 10 and then extends downward to form a u-shape to provide a respective gripping surface at the base of the u-shape that is beyond a first side periphery of a front surface of the barbeque grill cover 10 and below a bottom periphery of the front surface of the barbeque grill cover 10. Each end portion 455 is positioned to terminate at associated bracket 452 in order to avoid catching clothing or other items. Central portion 457 is coupled to the rear portion of cover 10 via brackets 453. Central portion 457 is preferably elevated above the height of bracket 452 to ensure that handle 450 does not interfere with items which may be placed on the side shelves. Given that the gripping surfaces provided by curved members 458 and 459 are outside of the respective side periphery of the front surface of the barbeque grill cover 10 and below a bottom periphery of the front surface of the barbeque grill cover 10 (i.e., outside of and below the plane of the grill cooking surface), a user can open and close the cover 10 without being exposed to the cooking surface. A further embodiment may be provided in which the gripping portions of the curved members 458, 459 are covered with (or formed from) a thermally insulated material in order to protect the user from excessive heat during use.

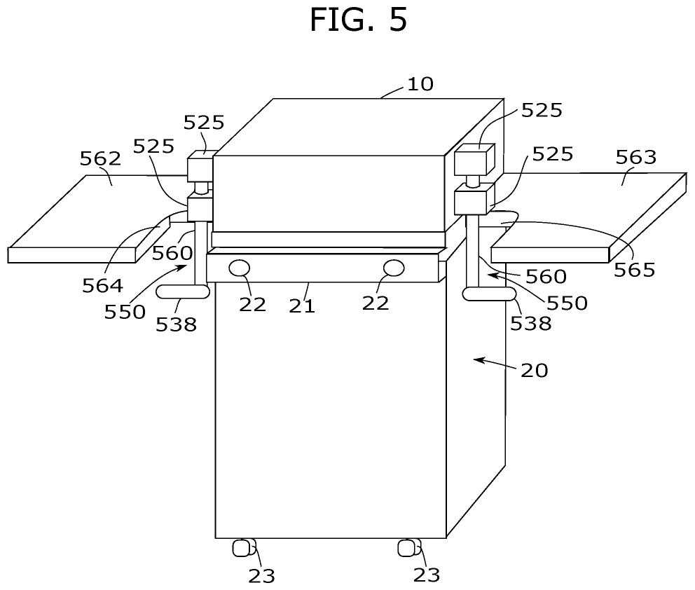

A fourth embodiment of a grill handle is shown in FIG. 5 which preferably includes two separate grill handles 550, each coupled to a respective side portion of cover 10. In some situations, only one grill handle 550 may be required. Each grill handle 550 consists of a vertical member 560 having a horizontal handle portion 538 coupled thereto at a first (distal) end thereof. Each vertical member 560 is adapted to be attached at a proximal end thereof to a side surface of the barbeque grill cover 10. Vertical member 560 has a length so that the distal end thereof extends below a bottom periphery of the side surface of the barbecue grill cover 10. Horizontal handle portion 538 is secured to the distal end of vertical member 560. Horizontal handle portion 538 provides a gripping surface that is beyond a side periphery of a front surface of the barbeque grill cover 10 and below a bottom periphery of the side surface of the barbecue grill cover 10. Each vertical member 560 is preferably coupled to two separate brackets 525 at the second (proximal) end thereof and is positioned in a vertical or near vertical position. In this embodiment, each side shelf 562, 563 is modified with a respective cut-out 564, 565 to allow the horizontal handle portion 538 to be positioned below the plane of the cooking surface when cover 10 is closed (which is approximately planar to the upper surface of each side shelf 563, 563) and preferably recessed under associated side shelf 563, 565 when cover 10 is a closed position. Since each horizontal handle portion 538 is outside of and below the plane of the cooking surface when the cover 10 is closed, a user can open and close cover 10 without being exposed to the cooking surface. A further embodiment may be provided in which each horizontal handle portion 538 is covered with (or formed from) a thermally insulated material in order to protect the user from excessive heat during use.

The present disclosure is also addressed to embodiments of a retrofit grill handle for a barbeque grill cover. The retrofit grill handle is adapted to be attached to a barbeque grill cover having an integral handle. The retrofit grill handle has a vertical member extending below a bottom periphery of a front surface of the barbecue grill cover, a horizontal handle portion secured to a distal end of the vertical member which provides a gripping surface that is beyond a side periphery of the front surface of the barbeque grill cover and below the bottom periphery of the side surface of the barbecue grill cover, and a clamping mechanism for securely attaching the vertical member to the integral handle of the barbeque grill cover at a proximal end of the vertical member.

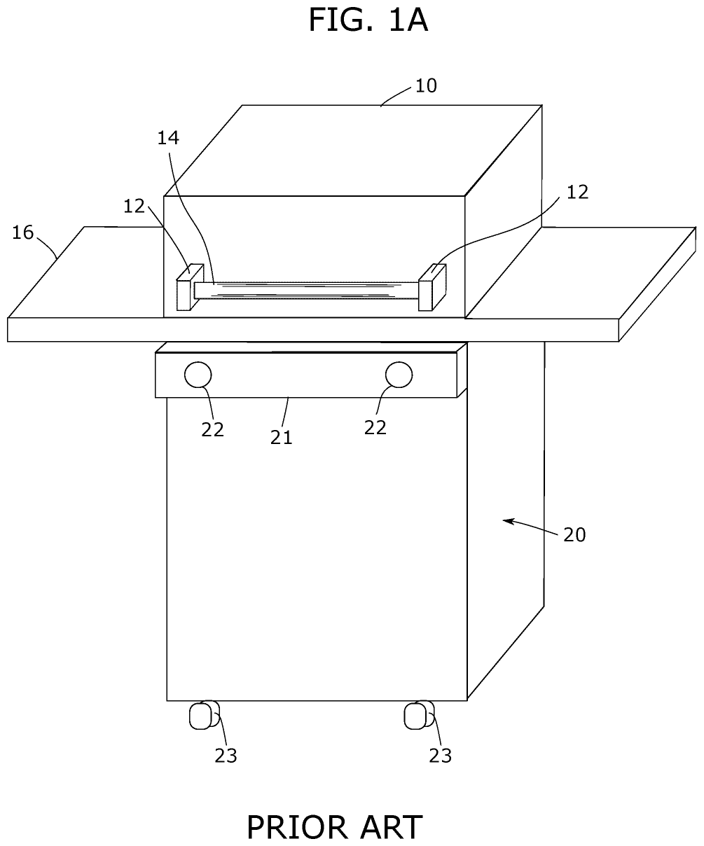

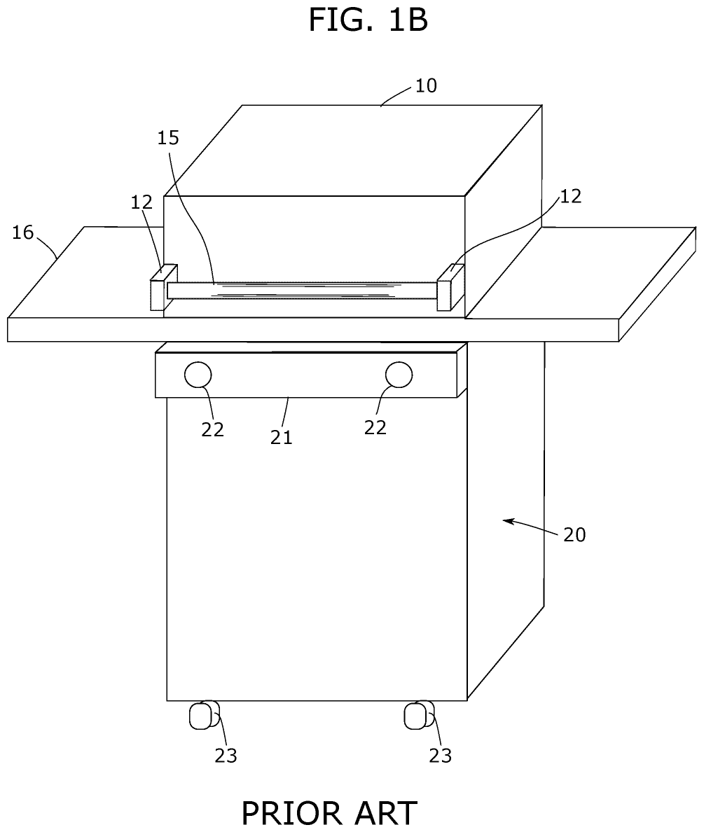

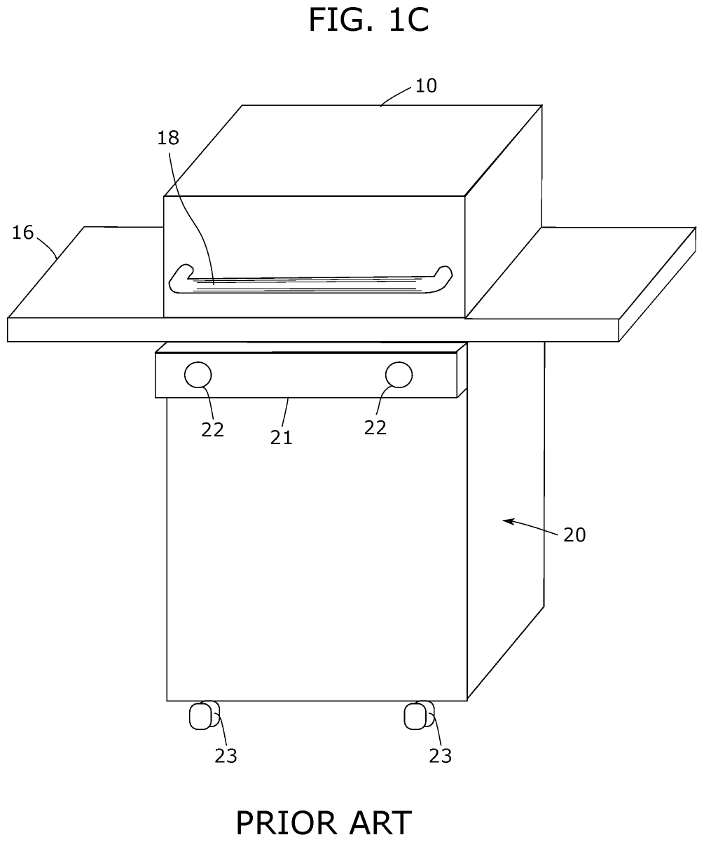

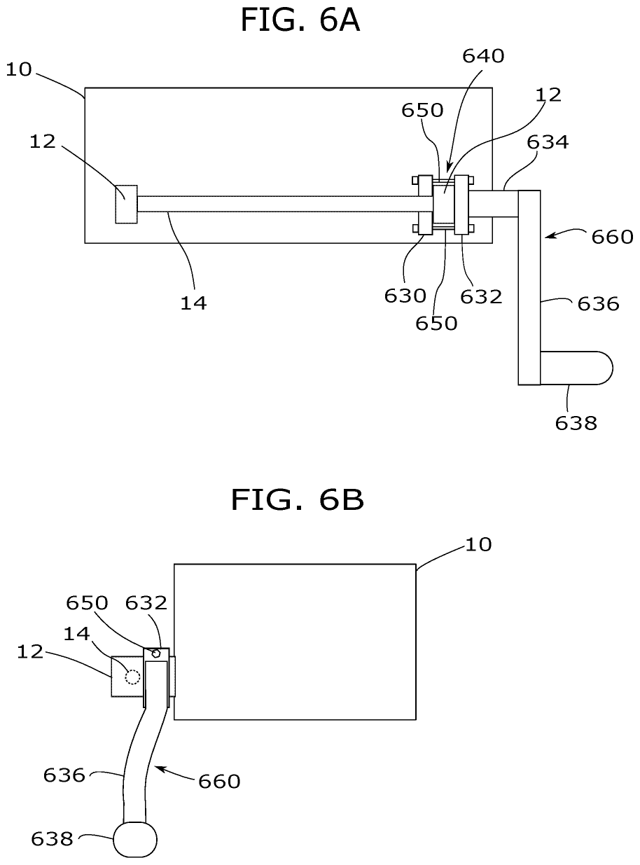

A fifth embodiment of the present disclosure is shown in FIGS. 6A and 6B which includes a retrofit grill handle 660 that is adapted to be attached to a conventional grill handle 14 (as shown in FIGS. 1A and 1B). Grill handle 660 includes a vertical member 636, a handle 638 mounted at a distal end of vertical member 636, an optional spacer 634, and a clamp mechanism 640 mounted to a proximal end of vertical member 636 (either directly or via spacer 634). Vertical member 636 may be slightly curved, as shown in FIG. 6B, in order to provide a more ergonomic solution, but in some cases may be completely straight. Spacer 634 is provided when bracket 12 is positioned away from the edge of front panel of grill cover 10 and is sized to ensure that handle 638 is positioned outside of and below the plane of the cooking surface when cover 10 is closed. Clamp mechanism 640 securely holds grill handle 660 to handle 14/bracket 12. Clamp mechanism 640 includes a first horizontal plate 632, a second horizontal plate 630, and securing hardware 650 (e.g., paired nuts and bolts) used to hold first horizontal plate 632 to second horizontal plate 630. Since handle 638 is positioned outside of and below the plane of the cooking surface when the cover 10 is closed, a user can open and close cover 10 without being exposed to the cooking surface. A further embodiment may be provided in which handle 638 is covered with (or formed from) a thermally insulated material in order to protect the user from excessive heat during use.

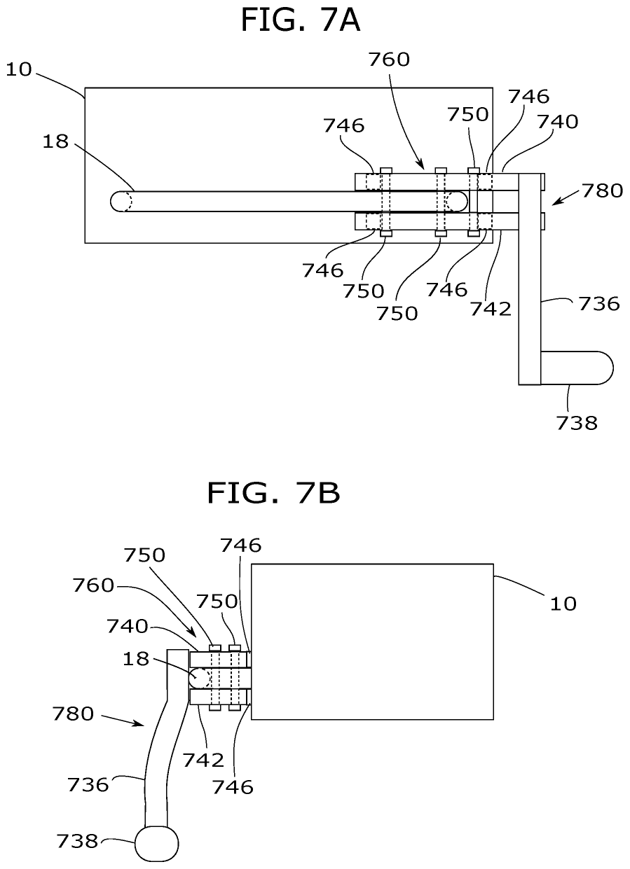

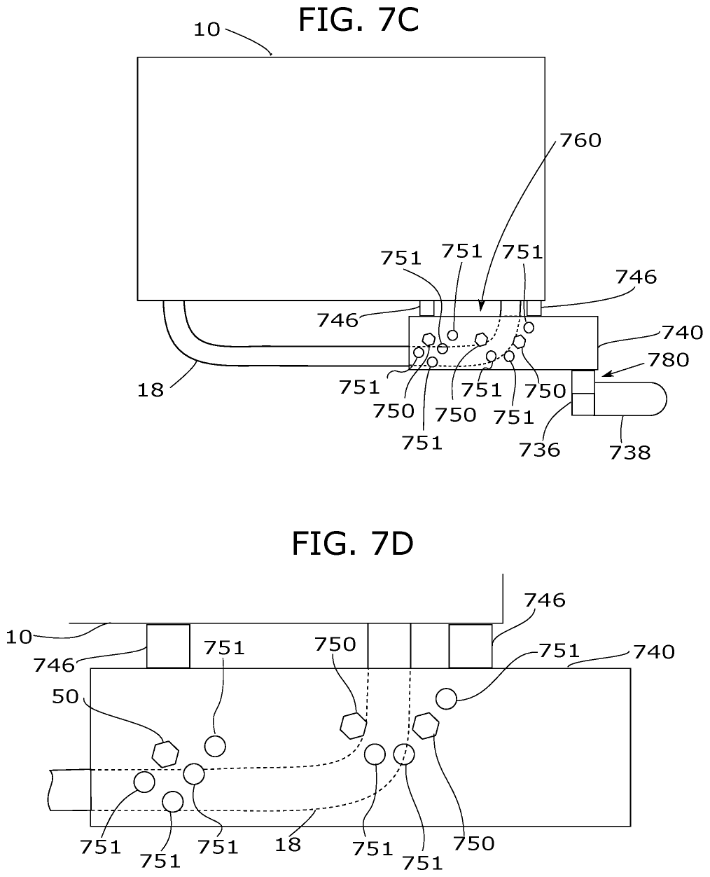

A sixth embodiment of the present disclosure is shown in FIGS. 7A-7D which includes a retrofit grill handle 780 that is adapted to be attached to a conventional grill handle 18 (as shown in FIG. 1C). Grill handle 780 includes a vertical member 736, a handle 738 mounted at a distal end of vertical member 736, and a clamp mechanism 760 mounted to a proximal end of vertical member 736. Vertical member 736 may be slightly curved, as shown in FIG. 7B, in order to provide a more ergonomic solution, but in some cases may be completely straight. Clamp mechanism 760 securely holds grill handle 780 to handle 18/bracket 12. Clamp mechanism 760 preferably includes a first vertical plate 740, a second vertical plate 742, and securing hardware 750 (e.g., paired nuts and bolts) used to hold first vertical plate 740 to second vertical plate 742. Upper vertical plate 740 is directly and fixedly (e.g., by welding or permanent adhesive, depending on the material composition of upper vertical plate 740 and vertical member) attached to vertical member 736. Lower vertical plate 742 is separate from vertical member 736 and can move vertically during the installation process to accommodate different cross sectional thicknesses for handles 18. In some cases it may be desirable to alternatively make lower vertical plate 742 fixed to handle 738 and upper vertical plate 740 separate. Since handle 738 is positioned outside of and below the plane of the cooking surface when the cover 10 is closed, a user can open and close cover 10 without being exposed to the cooking surface. A further embodiment may be provided in which handle 738 is covered with (or formed from) a thermally insulated material in order to protect the user from excessive heat during use. Spacers 746 may also be provided between the front surface of cover 10 and plates 740, 742 to avoid excessive heating of retrofit grill handle 780. Spacers 746 may be an insulated material such as a ceramic or heat-resistant plastic, or they may be a metal. Spacers 746 reduce the surface area of grill handle 780 in direct contact with the grill cover 10, thereby reducing any heat transfer from cover 10 to grill handle 780.

To provide flexibility in attaching grill handle 780 to existing grills, a plurality of holes 751 are located strategically in plates 740 and 742 to ensure that bolts 750 may be positioned within certain of the holes 751 to securely hold grill handle 780 to the existing handle 18. This is shown in FIGS. 7C and 7D where three bolts 750 are shown installed in holes not shown and with a number of holes 751 not used. In other applications (e.g., a grill having a handle 18 with a different diameter), bolts 750 may be installed in different positions. Preferably, two or more bolts 750 are installed interior to a space between grill cover 10 and handle 18, and one or more bolts 750 are installed exterior to that space in order to provide an even distribution of pressure on the existing handle 18 and to constrain any freedom of movement of grill handle 780 should any of the bolts 750 become loose. As evident, the same hole pattern is used for the two vertical plate 740, 742 so that the mating holes for a particular bolt 750 are vertically aligned. Note that there are alternate methods of achieving the design goal of clamping securely to the existing (prior art) grill handles. For example, bushings of various external diameters could be installed on the bolts (50) and fewer holes provided.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A handle for a barbeque grill cover, comprising:
a central portion adapted to be mounted to a front surface of the barbeque grill cover and having a width approximately equal to a width of the front surface of the barbeque grill cover; and
a first end portion extending from a first end of the central portion beyond a first side periphery of the front surface of the barbeque grill cover to provide a first gripping surface that is beyond the first side periphery of the front surface of the barbeque grill cover.

2. The handle of claim 1, further comprising:
a second end portion extending from a second end of the central portion beyond a second side periphery of the front surface of the barbeque grill cover to provide a second gripping surface that is beyond the second side periphery of the front surface of the barbeque grill cover.

3. The handle of claim 1, wherein the first end portion extends below a bottom periphery of the front surface of the barbeque grill cover to provide an extended first gripping surface that is beyond the first side periphery of the front surface of the barbeque grill cover and below the bottom periphery of the front surface of the barbeque grill cover.

4. The handle of claim 2, wherein the second end portion extends below a bottom periphery of the front surface of the barbeque grill cover to provide an extended second gripping surface that is beyond the second side periphery of the front surface of the barbeque grill cover and below the bottom periphery of the front surface of the barbeque grill cover.

5. The handle of claim 3, wherein the first end portion is curved and forms a u-shape.

6. The handle of claim 4, wherein the second end portion is curved and forms a u-shape.

7. The handle of claim 3, wherein the first end portion is curved and forms a closed loop.

8. The handle of claim 4, wherein the second end portion is curved and forms a closed loop.

9. The handle of claim 1, wherein the central portion is straight.

10. The handle of claim 2, wherein the central portion and the first and second end portions are formed from one of a metal material, a durable plastic material, or a wood material.

11. The handle of claim 1, further comprising a thermally insulated material covering the first gripping surface of the first end portion.

12. The handle of claim 2, further comprising a thermally insulated material covering the second gripping surface of the second end portion.

13. A handle for a barbeque grill cover, comprising:
a straight central portion adapted to be mounted to a rear surface of the barbeque grill cover and having a width greater than a width of the rear surface of the barbeque grill cover; and
a first end portion extending forward from a first end of the central portion to a point beyond a plane formed by the front surface of the barbeque grill cover and then extending downward to form a u-shape to provide a first gripping surface at the base of the u-shape that is beyond a first side periphery of a front surface of the barbeque grill cover and below a bottom periphery of the front surface of the barbeque grill cover.

14. The handle of claim 13, further comprising:
a second end portion extending forward from a second end of the central portion to a point beyond a plane formed by the front surface of the barbeque grill cover and then extending downward to form a u-shape to provide a second gripping surface at the base of the u-shape that is beyond a second side periphery of the front surface of the barbeque grill cover and below a bottom periphery of the front surface of the barbeque grill cover.

15. A handle for a barbeque grill cover, comprising:
a vertical member adapted to be attached at a proximal end thereof to a side surface of the barbeque grill cover, the vertical member extending below a bottom periphery of the side surface of the barbecue grill cover; and
a horizontal handle portion secured to a distal end of the vertical member, the horizontal handle portion providing a gripping surface that is beyond a side periphery of a front surface of the barbeque grill cover and below a bottom periphery of the side surface of the barbecue grill cover.

16. A retrofit handle for a barbeque grill cover having an integral handle, comprising:
a vertical member extending below a bottom periphery of a front surface of the barbecue grill cover;
a horizontal handle portion secured to a distal end of the vertical member, the horizontal handle portion providing a gripping surface that is beyond a side periphery of the front surface of the barbeque grill cover and below the bottom periphery of the side surface of the barbecue grill cover; and
a clamping mechanism for securely attaching the vertical member to the integral handle of the barbeque grill cover at a proximal end of the vertical member.

17. The retrofit handle of claim 16, wherein the clamping mechanism comprises:
a first horizontal plate securely attached to the vertical member at the proximal end thereof;
a second horizontal plate adapted to be positioned between the integral handle and an exterior surface of a front surface of the barbeque grill cover; and
hardware for securely fastening the first horizontal plate to the second horizontal plate.

18. The retrofit handle of claim 17, wherein the hardware comprises mating nuts and bolts.

19. The retrofit handle of claim 17, wherein a spacer is positioned between the first horizontal plate and the vertical member to ensure that the vertical member is positioned beyond the side periphery of the front surface of the barbeque grill cover.

20. The retrofit handle of claim 16, wherein the clamping mechanism comprises:
a first vertical plate securely attached to the vertical member at a proximal end thereof and adapted to be positioned above or below the integral handle;
a second vertical plate adapted to be positioned below or above the integral handle; and
hardware for securely fastening the first vertical plate to the second vertical plate.

21. The retrofit handle of claim 20, wherein the hardware comprises mating nuts and bolts.
